(19) United States
(12) Patent Application Publication
(10) Pub. No.: US 2010/0274622 A1
(43) Pub. Date: Oct. 28, 2010

(54) System and Method for Publishing collaboration

(76) Inventors: Meghan J. KENNEDY, Palo Alto, CA (US); Nathan Moroney, Palo Alto, CA (US); Udi Chatow, Palo Alto, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/431,437

(22) Filed: Apr. 28, 2009

(51) Int. Cl. G06F 3/01; G06F 15/16; G06Q 10/00; G06Q 50/00

(52) U.S. Cl. 705/9; 715/753; 709/204

(57) ABSTRACT

A system and method is disclosed for publishing collaboration. The method discloses: defining a publishing project requiring work product from a set of contributors; associating selectively editable project elements with the contributors; and storing the work product associated with the project elements in a project repository, which is accessible to all of the contributors. The system discloses a server configured to operate a series of modules, wherein the modules comprise: a decomposition module and a project permissions module for associating selectively editable publishing project elements with work product generated from a set of contributors; and a project repository for storing the work product associated with the project elements in a project repository, which is accessible to all of the contributors.

### BACKGROUND OF THE INVENTION

### Field of the Invention

The present invention relates generally to systems and methods for collaboration, and more particularly to publishing collaboration.

What is needed is a system and method for collaboration that overcomes the problems of the prior art.

### BRIEF DESCRIPTION OF THE DRAWINGS

Some embodiments of the invention are described, by way of example, with respect to the following figures:

FIG. 1 is one embodiment of a system 100 for publishing collaboration;

FIG. 2 is a pictorial diagram of one embodiment of a collaborative publishing project 200; and

FIG. 3 is a flowchart of one embodiment of a method 300 for publishing collaboration.

### DETAILED DESCRIPTION OF THE PREFERRED EMBODIMENT

In many domains, projects are created and completed according to a preferred set of roles and rules. Such projects can include the creation of: magazines, books, video, movies, slide shows, presentations, computer coding, and so on. Any sort of collaborative project.

These rules assure a level of quality that often separates a professional project result from an amateur one. As one example, a team of contributors can work together to complete a professional digital graphic design project. Such teams often communicate through email, on the phone, and in person to receive, make changes to, and hand off various project files between each other. Content providers send project content to designers. Designers add value to the content and send their product to Project Editor. Changes/comments/annotations by the Project Editor would then be sent back to the Designer, who would make the changes to the file and resend a new version of the project back to the Editor, and so on.

Such an approach necessitates a back-and-forth exchange of large files, emails, phone calls, meetings, etc and inherently increases the chances of miscommunication between the various project team members, as well as increasing the potential to accidentally overlook smaller changes, such as the addition or deletion of a period within a paragraph. This back and forth exchange would continue until all project team members (i.e. contributors) were satisfied, after which the project file could be output for production.

Such an approach is time-consuming for all involved. For instance, many changes essentially have to be made twice—once by the editor in communication to the designer, and once by the designer within the project file. Also, the documentation of these changes is spotty and/or disorganized, with multiple versions of files saved on the various contributor's computers, along with a generally haphazard collection of verbal and written requests for changes that have been exchanged between editors and designers.

Finally, depending upon a project's size and/or complexity, an exchange of very large files between project members may be required—whether in the form of images and other assets for the project, and the project file itself. Such large files themselves often can create unnecessary technical obstacles to getting a design project completed (i.e. maximum file size barriers in e-mail, setup of FTP, FedEx/messenger delivery of files on disk, etc).

The present invention, which is now discussed, is a system and method for multi-party project collaboration. It has many advantages that improve upon current project collaboration systems and methods. For instance, the present invention enables a multi-editor, multi-contributory architecture where in parties log-in and edit just their area depending upon their specialty skills or editing permissions, thereby solving a number of “organizational problems” seen in some pre-production processes and streamlining the whole creation process. Centralized storage of all documents and assets associated with a project significantly reduces a need to exchange files between members of a project, enables better version tracking, permits project contributors to work in parallel, and in general cuts down on the time spent editing a graphic design project by allowing editors to make changes themselves without going through a designer, thereby reducing opportunities for miscommunication. The present invention is particularly valuable for more complex projects, requiring a large team effort over a longer time period.

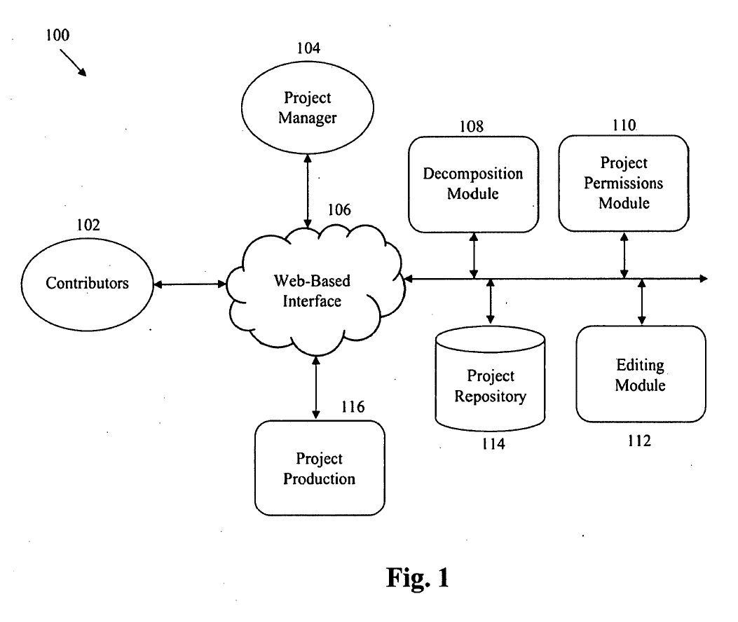

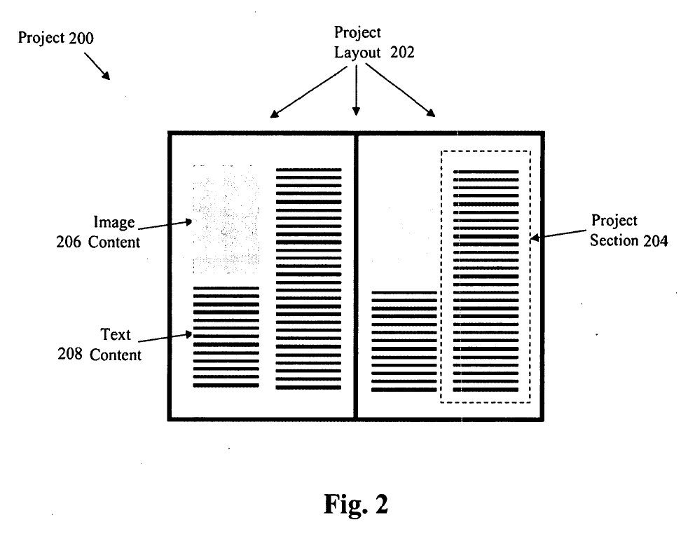

FIG. 1 is one embodiment of a system 100 for publishing collaboration. The system 100 includes one or more contributors 102, one or more project managers 104, a web-based interface 106, a decomposition module 108, a project permissions module 110, an editing module 112, a project repository 114, and a project production element 116. FIG. 2 is a pictorial diagram of one embodiment of a collaborative publishing project 200. The project 200 includes a project layout 202, and a variety of project elements such as a project section 204, image content 206, and text content 208. Both FIGS. 1 and 2 will now be discussed together, in terms of both an exemplary system 100 for creating projects, and an exemplary project 200 created by the system 100.

The project manager 104 can be thought of as a master-level editor who defines a new project 200, identifies contributors 102 to the project 200, and manages the system's 100 resources such that the project 200 is completed. To begin, project 200 is defined by the project manager 104. Project 200 is this embodiment is a magazine, but those skilled in the art recognize that the teachings of this invention can be applied to a variety of projects including not only works of authorship, as typically would be the subject matter of copyright, but also to any project preferably requiring a coordinated team effort.

Next, the project manager 104 defines the project layout 202. The project layout 202 describes a very flexible format that depends directly on the project 200 being created. The present invention provides a variety of options for generating the project layout 202, including generating the project layout 202 directly using one or more software applications, soliciting the project layout 202 from one of the contributors 102, or selecting the project layout 202 from a set of project templates stored in the project repository 114.

Where the project manager 104 solicits the project layout 202 from one of the contributors 102, that contributor is called a designer. The project manager 104 can in one embodiment identify the designer though a bidding process presented through the web-based interface 106. The designer selected by the project manager 104 then creates the project layout 202 in accordance with the project manager's 104 project criteria. The designer then uploads the project layout 202 into the project repository 114.

Alternatively, the project manager 104 can select a template, previously stored in the project repository 114, for the project layout 202. This template serves as the starting point for the project 200. The incorporation of templates solves the additional problem faced by those wanting to create a project in the absence of a designer, while still maintaining various pre-set stylistic elements. In FIG. 2, the project manager 104 has selected a magazine project layout.

Next the project manager 104 uses the decomposition module 108 to decompose the project 200 into a set of task-specific and/or role-based activities to be performed on various project elements by one or more of the contributors 102. These activities may span all or only a part of the project 200. These activities may also span all or part of the duration of the project 200, where some contributors create an initial set of works at the beginning of the project 200 and a different set of contributors complete a variety of editorial and finishing activities toward the end of the project 200.

A partial list of various task-specific and role-based activities into which the project manager 104 can decompose the project layout 202 are now presented. Those skilled in the art will recognize that, depending upon the project 200, this list can be appreciatively expanded. These activities include: graphical design; project layout; image creation; text composition; spell checking, formatting; multi-media creation; sound creation; cover page; side bar; editing; coding; programming; testing; compliance verification; copyright authorizations; and so on.

In the FIG. 2 example, the project manager 104 has decomposed the magazine project layout 202 into a project section 204, image content 206, and text content 208 based on task-specific publication activities. Not shown in FIG. 2 are some other project elements into which the project manager 104 has decomposed the project layout 202, perhaps including: additional pages; and a front and back cover. Had the project manager 104 selected instead a movie project layout, the project elements into which the project manager 104 might decompose the layout would be very different, perhaps including a set of scenes, a lead in, and credits.

Now the project manager 104, using the project permissions module 110, associates a set of authorization permissions with each of the project elements. These permissions define which one or more of the contributors 102 can add to and/or edit the various project elements. These permissions also define various time windows for when such additions and edits can be made, perhaps based on the various stages of project creation and derivative works.

For example, in FIG. 2, one of the contributors 102 is only allowed to edit content in project section 204, regardless of the type of content. Another one of the contributors 102 is only allowed to edit image content 206, but may edit image content 206 wherever it occurs throughout the project 200. Yet another one of the contributors 102 is only permitted to edit text content 208, but may edit text content 208 wherever it occurs throughout the project 200. Other contributors 102 may only have permission to create and edit a cover of the magazine, and so on.

The combined processes of project decomposition and contributor permissions thus creates independently editable project elements that each are associated with a particular contributor role and/or skill. The present invention thus allow multiple contributors 102 to work simultaneously in parallel to make changes to their respective elements within the project 200 while maintaining the integrity of the project 200 as a whole. Role and skill based permissions/authorizations thereby ensures that certain project elements are protected, while changes are being made to other project elements.

The contributors 102 themselves area very wide ranging group of entities that are solicited and/or brought together by the project manager 104, though the web-based interface 106, to effect the various project elements. Contributors 102 can include a variety of professionals having capabilities commensurate with one or more of the role or skill based activities. Contributors 102 can also include certain automated functions, such as automated spell check programs, content verification programs, indexing and formatting programs, and such.

With project 200 decomposed, permissions set for the various project elements and the contributors 102 identified, each authorized contributor either logs-in to the project 200 through the web-based interface 106, or directly accesses the project 200 through an internal network hosting the editing module 112 and project repository 114.

Next, contributors 102 access (e.g. “check out”) those project elements for which they have been granted permission, and, using the editing module 112, begin generating work product (e.g. inserting text, images, or editing, etc.). After completion, the contributors 102 either upload, through the web-based interface 106, or save their work product directly into the project repository 114.

At the discretion of the project manager 104, contributors 102 can view each others changes, and optionally add comments (e.g. annotations) to project elements which they do not have the authorization to edit. The contributors 102 changes are tracked as versions within the project repository 114.

The project repository 114 preferably provides for a common authoritative source for all documents and assets associated with a project. This common source reduces and/or eliminates a need for duplicate versions of project resources to be distributed between the various contributors 102 and the project manager 104, thereby enabling better version tracking and providing ready access to latest versions of various project 200 elements. Version tracking permits project changes to be tracked in the system 100, and also organizes the changes made to the project 200 over time thereby allowing all contributors to review changes made by others.

While the project repository 114 can be physically located on one or more co-located servers, other embodiments of the system 100 may use virtual storage techniques to permit the project repository 114 to be physically distributed over a variety of physical locations. Some project 200 elements stored in the project repository 114 include: project documents, templates, project assets, a main project file, auxiliary files, logos, images, text documents, and so on.

Once all the contributors 102 have made their desired changes and signed off on the project, and upon a decision by the project manager 104 that the project 200 is complete, the project 200 is sent by the project manager 104 to the project production 116 element. The project production 116 element is akin to publication for the magazine project discussed herein, but has an equivalent depending upon the particular project layout 202 (e.g. rendering for a media project).

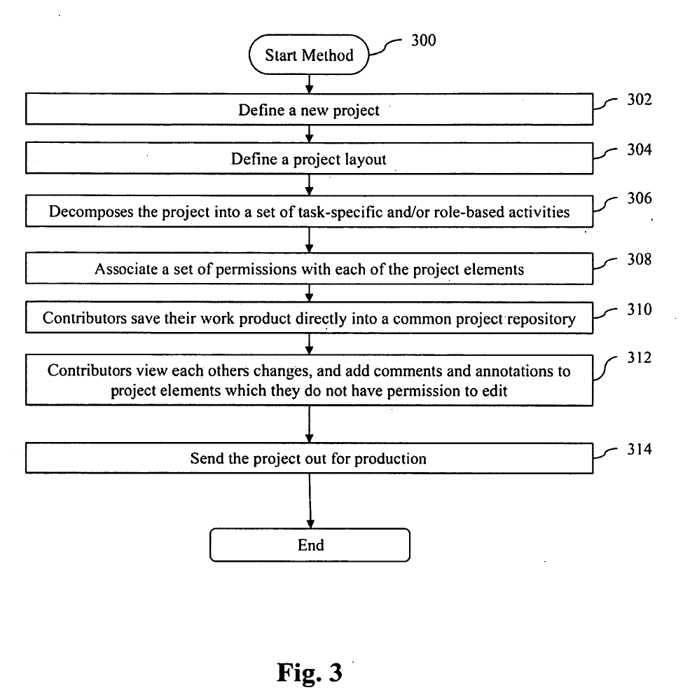

FIG. 3 is a flowchart of one embodiment of a method 300 for publishing collaboration. Those skilled in the art will recognize that while one embodiment of the present invention's method is now discussed, the material in this specification can be combined in a variety of ways to yield other embodiments as well.

The method steps now discussed are to be understood within a context provided by this and other portions of this detailed description. The method 300 begins in step 302, where the project manager 104 defines a new project. Next, in step 304, the project manager 104 defines a project layout. In step 306, the project manager 104 decomposes the project into a set of task-specific and/or role-based activities to be performed on various project elements by one or more of the contributors. In step 308, the project manager 104 associates a set of permissions with each of the project elements. Next, in step 310, the contributors 102 save their work product directly into the common project repository 114. In step 312, the contributors can view each others changes, and add comments (i.e. annotations) to project elements which they do not have the permission to edit. Then in step 314, the project manager 104 sends the project out for production.

Projects typically include a set of files, which also can refer to any collection of files, such as a directory of files. A “file” can refer to any data object (e.g., a document, a bitmap, an image, an audio clip, a video clip, software source code, software executable code, etc.). A “file” can also refer to a directory (a structure that contains other files).

The present invention is preferably implemented using the web-based interface 106 connected to a set of servers and storage resources scaled to the project's 200 complexity. These resources, perhaps distributed over various locations, host the functionality describe with respect to the contributors 102, project manager 104, decomposition module 108, project permissions module 110, editing module 112, project repository 114, and project production element 116.

Instructions of software described above are loaded for execution on a processor. The processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations thereof. It is intended that the following claims cover such modifications and variations as fall within the true spirit and scope of the invention.

1. A method comprising:
executing program code on a computer system to define a publishing project requiring work product from a set of contributors;
executing program code on the computer system to associate selectively editable project elements with the contributors and associate a set of contributor permissions with the project elements;
storing the work product associated with the project elements in a project repository on the computer system, which is accessible to all of the contributors; and
executing program code on the computer system to permit a contributor to only edit the project elements for which the contributor has permission.

2. The method of claim 1 wherein contributors include one from a group of:
a set of professionals having capabilities commensurate with the associated project elements, including one from a group of: text editing, media editing, and image editing; and
a set of automated functions, including one from a group of: spell check programs, content verification programs, indexing programs, and formatting programs.

3. The method of claim 1, wherein associating includes:
decomposing the project into one of: a set of task-specific project activities, and a set of role-based project activities;
associating the project elements with the project activities;
associating a set of contributor permissions with activities; and
permitting a contributor to only effect those project activities for which the contributor has permission.

4. The method of claim 3 further comprising:
permitting the contributor to view changes to all project elements; and
permitting the contributor to add comments to those project elements for which the contributor does not have the permission to edit.

5. The method of claim 3 wherein the activities include one of: graphical design; project layout; image creation; text composition; spell checking, formatting; multi-media creation; sound creation; cover page generation; side bar generation; editing; coding; programming; testing; rule compliance verification; and annotations.

6. The method of claim 3 wherein associating a set of contributor permissions includes:
varying contributor permissions over various time windows defined over a life of the project.

7. The method of claim 1 wherein the project includes one from a group of:
a magazine, a copyrightable work of authorship, a computer program, and a data compilation.

8. The method of claim 1 further comprising:
defining a project layout; and
wherein the layout is created using one from a group including: a software application; a layout designer; and a template stored in the project repository.

9. The method of claim 1 wherein storing the work product includes:
storing one from a group of: project elements; project layout templates; project assets; a main project file; auxiliary files; logos; images; text documents; and different project versions.

10. The method of claim 1 further comprising:
sending the project out for production; and
wherein production includes one from a group of: electronic publication, hardcopy publication, and rendering.

11. An article comprising at least one computer-readable storage medium containing instructions that when executed cause a computer to effect publishing collaboration by:
defining a publishing project requiring work product from a set of contributors;
associating selectively editable project elements with the contributors and associating a set of contributor permissions with the project elements;
storing the work product associated with the project elements in a project repository, which is accessible to all of the contributors; and
permitting a contributor to only edit those project elements for which the contributor has permission.

12. The instructions of claim 11 further including:
decomposing the project into one of: a set of task-specific project activities, and a set of role-based project activities;
associating the project elements with the project activities;
associating a set of contributor permissions with activities; and
permitting a contributor to only effect those project activities for which the contributor has permission.

13. The instructions of claim 12 wherein associating a set of contributor permissions includes:
varying contributor permissions over various time windows defined over a life of the project.

14. A system for publishing collaboration, comprising:
a server configured to operate a series of modules, wherein the modules comprise:
a decomposition module and a project permissions module for associating selectively editable publishing project elements with work product generated from a set of contributors and associating a set of contributor permissions with the project elements, the project permissions module to permit a contributor to only edit those project elements for which the contributor has permission; and
a project repository for storing the work product associated with the project elements in a project repository, which is accessible to all of the contributors.

15. The system of claim 14, wherein the project permissions module further comprises functionality for varying contributor permissions over various time windows defined over a life of the project.

16. The system of claim 14, further comprising:
a web-based interface for enabling the contributors to access the server and modules therein.

17. The system of claim 14, further comprising:
an editing module for enabling the contributors to modify a project element with their work product.
